(19) United States
(12) Patent Application Publication
(10) Pub. No.: US 2013/0317902 A1
(43) Pub. Date: Nov. 28, 2013

(54) SYSTEM AND METHOD FOR ADVERTISING REAL ESTATE

(71) Applicant: David Musiov, Oak Park (AU)

(72) Inventor: David Musiov, Oak Park (AU)

(21) Appl. No.: 13/897,815

(22) Filed: May 20, 2013

(30) Foreign Application Priority Data
May 28, 2012 (AU) 2012902191

(51) Int. Cl. G06Q 30/02; G06Q 50/16

(52) U.S. Cl. CPC G06Q 30/0257; G06Q 50/16
USPC 705/14.45; 705/14.55

(57) ABSTRACT

A system for advertising real estate includes providing a signboard located at a property that includes a property identification code; mobile device application software provided on a mobile device including a user interface facilitating registration and optionally other application software configuration options, the mobile device application software and user interface including provisions for entry of the property identification code; and a database hosted on a remote server(s) associated with the mobile device application software including real estate information on the property corresponding to the property identification code. Entry of the property identification code into the mobile device application software provided on the mobile device results in the transfer of the real estate information corresponding to the property identification code to the mobile device.

### TECHNICAL FIELD

The present invention relates to a system and method for advertising real estate. In particular, the invention provides a system and method that facilitates easy access to information relating to a property for sale or lease and that optionally facilitates exchange of information between buyer and seller or agent.

### BACKGROUND

The most widely accepted methods for advertising of real estate include printed publications, for example in newspapers and magazines, and advertising on web-based real estate sites, such as realestate.com. These forms of advertising provide buyers with detailed information about the property for sale, including location, number of rooms, special features of the property, optionally a price range for the property, open house dates and times, auction date and so on.

In addition to printed and internet publication of property details as outlined above, in most instances the property itself will also be provided with a signboard, generally erected outside the property. This is the case for domestic, rural, industrial and commercial real estate alike. Signboards generally include similar information to that provided in printed and internet publications relating to the property. Contact details for the agent selling or leasing the property are also generally provided so that passers-by can contact the agent to obtain additional information about the property. While this may be of value for those walking past the property that may be able to stop and physically record all of the details, it is more difficult for those who are driving past the property, unable to stop, are in a hurry or don't have a pen and paper to record the various details on the signboard, for example the seller's or agent's name, phone number(s), email address(s) and the physical address of the property. This may lead to people of interest forgetting the property details and therefore failing to obtain more detailed information on the property or register their interest in the property and ultimately could result in the loss of a potential buyer.

In more recent times signboards are displaying QR codes. QR codes, or Quick Response Codes, are a type of matrix barcode or two dimensional code consisting of black modules arranged in a square pattern on a white background. The information encoded when used in real estate advertising, once scanned by a smart phone, will redirect the potential buyer to a URL. This may be the website of the real estate agent selling the property, but may also link the potential buyer to a video of the property being sold. In any event, in the case of QR codes, the potential buyer of the property must be in a position to scan the QR code. That is, they must be on street level at the signboard with their smart phone to obtain the relevant information. The system is therefore not suitable for those driving past the property and suffers the same problem referred to above. QR codes are generic with many uses and are not real estate specific and therefore don't return real estate specific information, QR codes appear in magazines, brochures and food packaging.

### SUMMARY OF THE INVENTION

According to one aspect of the invention there is provided a system for advertising real estate including:

a signboard located at a property that includes a property identification code;

mobile device application software provided on a mobile device including a user interface facilitating registration and optionally other application software configuration options, the mobile device application software and user interface including provisions for entry of the property identification code; and

a database hosted on a remote server(s) associated with the mobile device application software including real estate information on the property corresponding to the property identification code;

wherein entry of the property identification code into the mobile device application software provided on the mobile device results in the transfer of the real estate information corresponding to the property identification code to the mobile device.

As used herein, the term “signboard” includes within its scope any form of street front signage indicating a property for sale, lease or otherwise.

As used herein, reference to the term “property” includes reference to commercial, industrial, rural and residential real estate or otherwise.

As used herein the term “mobile device” includes within its scope mobile phones, such as smart phones, and tablets, such as the iPad or Galaxy Tab, or any other form of like-mobile device.

The mobile device application software may allow for user registration and other setup/configuration. User registration will store the user's preferred contact details including, but not limited to, name, email address and phone numbers(s). There may also be provision for the configuration of notifications, notification method (mobile device application Alert, Email, SMS and the like), notification periods and notification frequency this includes but is not limited to Open for Inspection (Date and Time) and Auctions (Date and Time). As such, in a preferred embodiment, the system includes user registration and/or other setup/configuration including, for example, notifications wherein the information is stored within the mobile device application software on the mobile device and/or on a database hosted on a remote server(s). In practice, according to this embodiment of the invention, when a user downloads the mobile device application software to their mobile device, they will be presented with a log in page requesting certain information from them. This information may be used to notify a vendor of interest in the property, as discussed below.

In many instances, vendors, such as real estate agents or private sellers, who subscribe to the system, will wish to obtain information on the level of interest in the property, The data collected by the system may vary and a degree of flexibility is preferably inbuilt to the system. In one embodiment, entry of the property identification code into the mobile device application software by the user notifies the vendor of the level of interest in the property. That is, when a user of the mobile device application software enters a property identification code to retrieve real estate information on the property in question, the vendor receives notification that a user has retrieved the information. This process may not necessarily result in any personal information of the user being passed on to the vendor, although this is a possible additional feature as discussed below. In an embodiment, the vendor may be notified on a daily, weekly, monthly or ad hoc basis of the number of “hits” or inquiries the property receives. That is, the vendor may be notified of the number of times the real estate information on the property is accessed. The system may also enable a user to confirm interest in attending an upcoming open house or auction, without necessarily divulging any personal information to the vendor. Which details, if any, are passed to the vendor will be determined by the user setup/configuration

As used herein, the term “vendor” is used in its broadest sense and includes not only the property owner, but also any agent, companies or representative of the property owner. Generally, the term refers to the agent selling or leasing the property.

In another embodiment, the vendor is notified of details of a user of the mobile device application software accessing the real estate information on the property, based on user information entered by the user. This information will generally be obtained from the user on registering their details and based on the setup/configuration options chosen. This embodiment of the invention may be of particular value to vendors, such as real estate agents, as it may give them valuable information on the demographics of the marketplace in terms of buyers, price range interest, property type interest in certain locations and so on.

The information provided to the user of the system is not particularly limited. For example, the real estate information may include but is not limited to one or more of property size, number of rooms, special property features, age of the property, contact details, address/location, car spaces, estimated property price range, date available, open house dates and times and auction dates and times, if applicable. If desired, the real estate information retrieved may include but is not limited to maps, directions, photographs or a virtual tour of the property. The granularity of detail displayed, downloaded or retrieved to mobile device application software will be determined by the user setup/configuration. The mobile device application software may also include the ability to share details of the property with friends.

In certain embodiments, a user of the mobile device application software can opt in to be notified of other properties in the vicinity of the property corresponding to the property identification code entered and/or other properties similar to the property corresponding to the property identification code entered. It is envisaged that this may be an attractive option for people attending open houses during a weekend, or driving through a suburb identifying properties for sale or lease. They may simply identify one property in an area of interest and opt in for notification of other properties and quickly receive either a list or a map on their mobile device identifying those properties. Likewise, users may identify a property within a particular style or price range and be provided with a map identifying like-properties within a certain distance or a list of like-properties. Notification of other properties may be immediate and/or ongoing (i.e. future notification).

As such, in one embodiment the notification of other properties includes real estate information on the other properties and/or provides the user with a map on the mobile device with the locations of the other properties or optionally directions to the other properties.

In certain embodiments, it is envisaged that the system may utilise geo-location, in which case the property identification code may not take the form of a physical number or word. In this embodiment, the property identification code may, for example, identify that the property is registered for geo-location and the mobile device application software may include a geo-location option whereby a user may choose to use their current location, as identified by their mobile device, to access the real estate information on the property.

Generally, notwithstanding the comments in the immediately preceding paragraph, the property identification code is an alpha numeric code. In that regard, as used herein the term “alpha numeric” is intended to include within its scope codes including letters, numbers and/or other characters and symbols, such as @ and so on.

In certain embodiments the system may provide the ability, based on configuration, to defer the downloading of the real estate information until a later time, on demand or when connected to WiFi. The granularity of detail and when and how to download may also be configurable.

In certain embodiments the system may provide the ability to update calendar software on the mobile device with an event/appointment based on Open for Inspection (Date and Time), Auction (Date and Time) or other event related to the property.

In some instances, a user may want to make a note or comment on the property. As such, in certain embodiments the system includes the ability in the mobile device application software to make notes/comments and/or to add photos, videos or voice memos against the property.

The system may also provide the user with the ability to ask the vendor question(s) either in real-time or in a deferred manner. This option may be configurable by the vendor for each property or as a default for the vendor.

In certain embodiments, it is envisaged that the mobile device application software, generally based on a user definable option, may utilise geo-location to shortlist probable property identification codes and/or to autocomplete the property identification code.

According to another aspect of the invention there is provided a method for advertising real estate including:

providing a signboard at a property that includes a property identification code;

providing mobile device application software for downloading to a mobile device, the mobile device application software including a user interface facilitating registration and optionally other application software configuration options, the mobile device application software and user interface including provisions for entry of the property identification code;

providing a database hosted on a remote server(s) associated with the mobile device application software including real estate information on the property corresponding to the property identification code; and

transferring the real estate information corresponding to the property identification code to the mobile device on registration of a user and entry of the property identification code into the user interface of the mobile device application software provided on the mobile device.

As with the previous aspect of the invention, the method may include requiring a user of the mobile device application software to enter user information for entry and storage on the mobile device application software or on a database(s) of user information. The information may include the user's name, address, email and so on.

Likewise, the method may include notifying a vendor of the level of interest in the property on entry of the property identification code into the mobile device application software. For example, the vendor may be notified of the number of times the real estate information on the property is accessed. The vendor may also be notified of details of a user of the mobile device application software accessing the real estate information on the property, based on user information entered by the user. In that regard, user information sent to the vendor may be optional, based on privacy settings chosen by the user.

The real estate information may include but is not limited to one or more of property sizes, number of rooms, special property features, age of the property, contact details, estimated property price range, date available, open house dates and times and auction dates and times, if applicable. Again, the information provided is not particularly limited and may also include, for example, maps, directions, photographs or a virtual tour of the property. The mobile device application software may facilitate sharing the real estate information with friends.

The method of this aspect of the invention may also include notifying a user of the mobile device application software of other properties in the vicinity of the property corresponding to the property identification code entered and/or other properties similar to the property corresponding to the property identification code entered. Again, notification of other properties may include immediate notification of the other properties and/or ongoing future notification of the other properties. The notification may include real estate information on the other properties and/or provide the user with either a list or a map on their mobile device with the locations of the other properties.

In certain embodiments, the property identification code identifies that the property is registered for geo-location and the method includes geo-locating the mobile device to access the real estate information on the property. Generally, geo-location will identify the closest property registered for geo-location and provide the user with details of that property. Information on properties close to the geo-location may also be supplied to the user.

In accordance with the previous embodiment of the invention, the property identification code is generally an alpha numeric code as previously defined.

In certain embodiments the method may include deferring downloading of real estate information until a later time, on demand or when connected to WiFi. In this embodiment, the granularity of detail and when and how to download may be configurable.

In certain embodiments the method includes updating calendar software on the mobile device with an event/appointment based on Open for Inspection (Date and Time), Auction (Date and Time) or other event related to the property.

The method may also include providing the user with the ability, in the mobile device application software, to make notes/comments and/or add photos, videos or voice memos against the property.

In certain embodiments the method may also include providing the ability of the user to ask the vendor question(s) either in real-time or in a deferred manner. This option may be configurable by the vendor for each property or as a default for the vendor.

In certain embodiments, the method may include utilising geo-location to shortlist probable property identification codes or to autocomplete the property identification code.

In some embodiments, it is envisaged that the mobile device application software may be provided through an existing platform, such as Twitter or Facebook or alike. In those cases, the property identification code may be a Twitter tag associated with the property and the real estate information may be provided through an associated Twitter account and property information could be sent directly from the real estate agent, in which case the database including the real estate information may be optional.

Therefore, according to another aspect of the invention there is provided a system for advertising real estate including:

a signboard located at a property that includes a property identification code;

mobile device application software provided on a mobile device including a user interface facilitating registration and optionally other application software configuration options, the mobile device application software and user interface including provisions for entry of the property identification code; and

a remote agent account corresponding to the property identification code;

wherein entry of the property identification code into the mobile device application software provided on the mobile device results in expression of interest in or following of the property, access to the remote agent account and real estate information corresponding to the property identification code through the user interface on the mobile device.

The additional features described above apply equally to this aspect of the invention and are explicitly incorporated into this aspect of the invention.

### BRIEF DESCRIPTION OF THE DRAWING

FIG. 1 illustrates a flow diagram of the system for advertising real estate.

### DETAILED DESCRIPTION

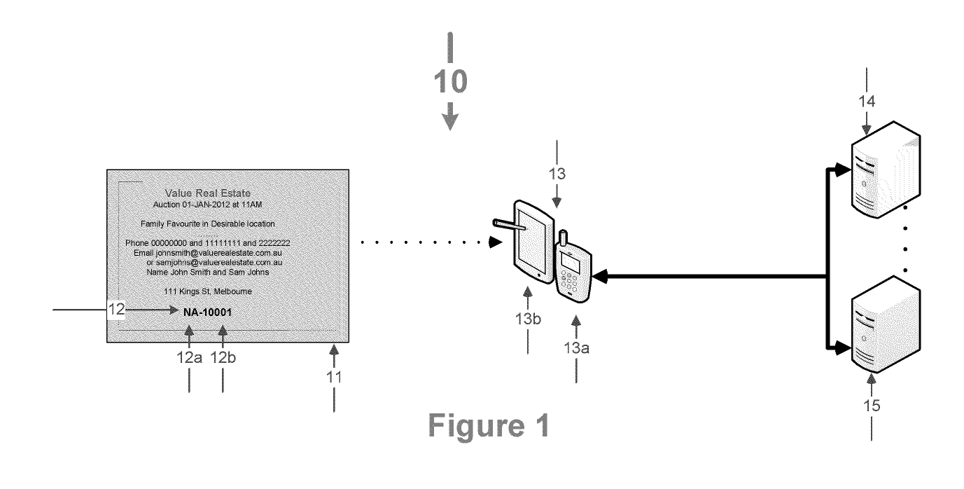

A more detailed description of embodiments of the invention will be provided with reference to the drawing. Referring to FIG. 1, a system 10 for advertising real estate is provided. The system includes a signboard 11 that includes relevant information on the property for sale, lease or otherwise. The signboard 11 is erected outside the property for sale or lease and includes a property identification code 12. The property identification code is unique to the property in question. In this instance, the property identification code 12 includes an alphabetic component 12a and a numeric component 12b. The alphabetic component 12a may by an abbreviation or indication of the name of an agent selling or leasing the property, while the numeric component 12b may be a code for the agent to suitably identify the property.

The system 10 includes a mobile device 13, depicted here as a smart phone 13a or tablet 13b. The mobile device 13 includes mobile device application software that may be, for example, downloaded as an “app” from an external source. The mobile device application software includes provision for the entry of the property identification code 12. On entry of the property identification code 12 into the mobile device application software, real estate information stored on an application database 14 and/or vendor database 15 is transmitted to the mobile device 13 thereby advising the user of the mobile device 13 of details relating to the property corresponding to the property identification code 12.

The user of the mobile device 13 may provide personal information on downloading the mobile device application software to their mobile device 13, although it is envisaged that this may be an optional feature of the mobile device application software. It is envisaged, though, that when the user of the mobile device 13 retrieves information on a property from a database 14 and/or 15, a vendor of the property, particularly an agent selling the property, is advised of interest in the property. This may be achieved by direct communication between the mobile device 13 and the vendor's database 15, or indirect communication via the application database 14, or an alternative reporting, statistics and vendor notification solution may be implemented. This will provide the vendor with information on the number of times the real estate information is accessed using the system 10, which will provide the vendor with some idea of the level of interest in the property.

It is envisaged that the system 10, through the mobile device application software on the mobile device 13, will have an “opt in” feature whereby a user of the system 10 may choose to provide the vendor with more detailed information on themselves. That information may be stored on the mobile device application software on the mobile device 13 of the user, or may be stored on the application database 14. As such, this information may be transmitted directly to the vendor from the mobile device 13 of the user of the system 10, or may be transmitted to the vendor from the application database 14, or via an alternative reporting, statistics and vendor notification solution.

When information has been exchanged between the vendor and user of the mobile device application software, the vendor may be in a position to provide the user with additional information on the property, for example advising the user of relevant open house times or auction dates, or information on other properties. Users can also be advised of Open House or Auction Cancellation or other information.

In cases where the database is replaced with a remote agent account, for example where a platform such as Twitter or Facebook is employed (e.g. where the property identification code is a Twitter tag), a real estate agent may directly interact with potential buyers of the property. For example, a Twitter Tag (property identification code) is displayed on the signboard located at a property. The Tag may be, for example, @RW1234, indicating an agent and property “Ray White 1234”, A person interested in the property enters the Twitter Tag into their Twitter app on their mobile device to “follow” the property. The real estate agent is then able to communicate with all of the followers of @RW1234. As tweets are limited to 140 characters, the first tweet could be a Welcome message with a Link (URL) or Video, or message. Following the initial Welcome message the real estate agent may send property details, such as number of bedrooms, car spaces, size, price, etc. People following may ask questions, such as “when is the next Open for Inspection”, “I'll be coming to the Auction—what's the reserve”, Likewise, the real estate agent may tweet events, such as “Next Open day is . . . ”. Once the property is sold the real estate agent can close the account (@RW1234).

Unless the context requires otherwise or specifically stated to the contrary, integers, steps or elements of the invention recited herein as singular integers, steps or elements clearly encompass both singular and plural forms of the recited integers, steps or elements.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A system for advertising real estate including:
a signboard located at a property that includes a property identification code;
mobile device application software provided on a mobile device including a user interface facilitating registration, the mobile device application software and user interface including provisions for entry of said property identification code; and
a database hosted on a remote server(s) associated with said mobile device application software including real estate information on the property corresponding to said property identification code;
wherein entry of said property identification code into said mobile device application software provided on said mobile device results in the transfer of said real estate information corresponding to said property identification code to said mobile device.

2. A system according to claim 1, wherein said mobile device application software includes a user configuration wherein the configuration is stored within at least one of the mobile device application software on the mobile device and on the database hosted on a remote server(s).

3. A system according to claim 1, wherein entry of said property identification code into said mobile device application software by a user notifies a vender of the level of interest in the property.

4. A system according to claim 3, wherein said vendor is notified of details of a user of the mobile device application software accessing said real estate information on the property, based on user information entered by the user.

5. A system according to claim 1, wherein said real estate information includes one or more of property size, number of rooms, special property features, age of the property, contact details, address/location, car spaces, estimated property price range, date available, open house dates and times and auction dates and times, if applicable.

6. A system according to claim 1, wherein a user of the mobile device application software can opt in to be notified of at least one of other properties in the vicinity of the property corresponding to the property identification code entered and other properties similar to the property corresponding to the property identification code entered, said notification of other properties including at least one of immediate notification of said other properties, ongoing future notification of said other properties, real estate information on said other properties and a map or list on said mobile device with the locations of said other properties.

7. A system according to claim 1, wherein said property identification code identifies that the property is registered for geo-location and said mobile device application software includes a geo-location option whereby a user may choose to use their current location, as identified by their mobile device, to access said real estate information on the property.

8. A system according to claim 1, wherein the property identification code is an alpha numeric code.

9. A system according to claim 1, wherein the system provides the ability, based on configuration, to conduct at least one of deferment of the downloading of the real estate information until a later time, on demand or when connected to WiFi, updating calendar software on the mobile device with an event/appointment based on Open for Inspection (Date and Time), Auction (Date and Time) or other event related to the property, making of notes/comments, adding of photos, videos or voice memos against the property, and asking a vendor of the property questions either in real-time or in a deferred manner.

10. A system according to claim 1, wherein the mobile device application software utilises geo-location to shortlist probable property identification codes and/or to autocomplete the property identification code.

11. A method for advertising real estate including:
providing a signboard at a property that includes a property identification code;
providing mobile device application software for downloading to a mobile device, said mobile device application software including a user interface facilitating registration, the mobile device application software and user interface including provisions for entry of said property identification code;
providing a database hosted on a remote server(s) associated with said mobile device application software including real estate information on the property corresponding to said property identification code; and
transferring the real estate information corresponding to the property identification code to the mobile device on registration of a user and entry of the property identification code into the user interface of the mobile device application software provided on the mobile device.

12. A method according to claim 11, including requiring a user of the mobile device application software to enter user information for entry and storage on the mobile device application software or on a database(s) of user information.

13. A method according to claim 11, including notifying a vender of the level of interest in the property on entry of said property identification code into said mobile device application software.

14. A method according to claim 13, wherein said vendor is notified of the number of times said real estate information on the property is accessed and/or said vendor is notified of details of a user of the mobile device application software accessing said real estate information on the property, based on user information entered by the user.

15. A method according to claim 11, wherein said real estate information includes one or more of property size, number of rooms, special property features, age of the property, contact details, estimated property price range, date available, open house dates and times and auction dates and times, if applicable.

16. A method according to claim 11, including notifying a user of the mobile device application software of at least one of other properties in the vicinity of the property corresponding to the property identification code entered and other properties similar to the property corresponding to the property identification code entered.

17. A method according to claim 16, wherein said notification of other properties includes immediate notification of said other properties and/or ongoing future notification of said other properties, and/or said notification includes real estate information on said other properties and/or provides said user with a map or list on said mobile device with the locations of said other properties.

18. A method according to claim 11, wherein said property identification code identifies that the property is registered for geo-location and said method includes geo-locating said mobile device to access said real estate information on the property.

19. A method according to claim 11, wherein the property identification code is an alpha numeric code.

20. A method according to claims 11, including deferring downloading of said real estate information until a later time, on demand or when connected to WiFi.

21. A method according to claim 11, including updating calendar software on the mobile device with an event/appointment based on Open for Inspection (Date and Time), Auction (Date and Time) or other event related to the property.

22. A method according to claim 11, including providing a user with the ability, in the mobile device application software, to make notes/comments and/or add photos, videos or voice memos against the property, and/or providing a user with the ability to ask a vendor of the property question(s) either in real-time or in a deferred manner.

23. A method according to claim 11, including utilising geo-location to shortlist probable property identification codes or to autocomplete the property identification code.

24. A system for advertising real estate including:
a signboard located at a property that includes a property identification code;
mobile device application software provided on a mobile device including a user interface facilitating registration and other application software configuration options, the mobile device application software and user interface including provisions for entry of the property identification code; and
a remote agent account corresponding to the property identification code;
wherein entry of the property identification code into the mobile device application software provided on the mobile device results in expression of interest in or following of the property, access to the remote agent account and real estate information corresponding to the property identification code through the user interface on the mobile device.

25. A system for advertising real estate including:
mobile device application software provided on a mobile device including a user interface facilitating registration of a user, the mobile device application software and user interface including provisions for entry of a property identification code located on a signboard located at a property;
wherein entry of said property identification code into said mobile device application software provided on said mobile device results in the transfer of real estate information corresponding to said property identification code to said mobile device, said real estate information being included on a database hosted on a remote server(s) associated with said mobile device application software.
